(19) United States
(12) Patent Application Publication
(10) Pub. No.: US 2004/0062039 A1
(43) Pub. Date: Apr. 1, 2004

(54) Portable electronic signal light with power self-generator

(76) Inventor: Chang-Sup Ahn, Daegu (KR)

Correspondence Address: DARBY & DARBY P.C., P. O. BOX 5257, NEW YORK, NY, 10150-5257, US

(21) Appl. No.: 10/433,583

(22) PCT Filed: Feb. 28, 2001
(86) PCT No.: PCT/KR01/00310

(30) Foreign Application Priority Data
Dec. 8, 2000 (KR) 2000/34455 U
Dec. 23, 2000 (KR) 2000/36259 U
Feb. 27, 2001 (KR) 2001/5209 U

(51) Int. Cl. F21L 13/00

(52) U.S. Cl. 362/192; 362/109; 362/800

(57) ABSTRACT

Disclosed is a portable signal light. The portable signal light comprises a signal light section and a self-generator. The signal light section has a hollow signal light body to an inner surface of which a light emitting sheet is attached, a vertically positioned panel which is located inside the hollow signal light body, a plurality of LED elements which are fastened to the vertically positioned panel to be spaced apart one from another by a predetermined distance, and an illuminating lamp which is integrally secured to the hollow signal light body. The self-generator functions to generate power to be fed as operating power to the LED elements of the signal light section, the illuminating lamp and an external load.

### TECHNICAL FIELD

The present invention relates to a portable signal light having coupled thereto a self-generator, and more particularly, the present invention relates to a portable signal light which is designed to be fed with operating power by a self-generator assembled to a lower end thereof, so as to emit light of a single color or multiple colors.

### BACKGROUND ART

Generally, a portable signal light which emits light of a single color (in most cases, a red color) is used to intentionally regulate traffic at night.

Describing a typical construction of a portable signal light, one lamp or a plurality of LED elements are arranged in a cylindrical red-colored signal light body. If a power switch is turned on, the lamp or LED elements are lighted or flickered to emit light of a red color, to thereby effect control over passage and stop of vehicles or pedestrians.

Also, in another construction of a portable signal light, a multitude of LED elements are arranged in a cylindrical signal light body in a manner such that they are controllably flickered in a preset sequence to display a figure or letters and thereby regulate traffic flow.

A portable signal light is not limitedly used to regulate traffic but can be used, for example, in a construction site at night or for exchanging signals with another person at a distant position.

Since most of the conventional portable signal lights use batteries as their power source, if a battery is discharged to a voltage level of no greater than a predetermined value, the battery must be replaced with a new one. Hence, in this type of a portable signal light which obtains operating power from a battery, due to a battery replacing operation, bothersomeness is caused to a user and inefficiency is induced in terms of economy.

Moreover, an officer on traffic duty carries around and frequently uses a portable radio transmitter for exchanging traffic information with headquarters or other officers. At this time, as in the case of the portable signal light, since the portable radio transmitter also obtains operating power from batteries and a battery replacing operation must be performed, bothersomeness is caused to a user and inefficiency is induced in terms of economy.

Further, in order for an officer to confirm an identity of a vehicle driver at night, a separate illuminating implement such as a flashlight is generally prepared independently of the portable signal light. Also, at this time, because the illuminating implement is fed with operating power from batteries and a battery replacing operation must be performed, uneconomy is caused.

Furthermore, since the portable signal light emits light of a single, that is, red color, control over passage and stop of vehicles or pedestrians is implemented using light of the same color. Therefore, the likelihood of drivers of the vehicles or the pedestrians to misperceive a traffic situation is increased.

### DISCLOSURE OF THE INVENTION

Accordingly, the present invention has been made in an effort to solve the problems occurring in the related art, and an object of the present invention is to provide a portable signal light which is fed with operating power from a self-generator integrally formed therewith or detachably coupled thereto, which has integrally installed thereon an illuminating lamp for illuminating a certain area, and which is designed to be capable of feeding charged power to an external load such as a portable radio transmitter.

Another object of the present invention is to provide a portable signal light which is modified in its construction in such a way as to allow a rotation torque-related characteristic of a self-generator integrally formed with or detachably coupled to a lower end of the portable signal light to be improved and to enable a battery pack to be detachably assembled to the portable signal light, so that a lamp or LED elements are lighted or flickered by power fed from the self-generator and power charged to the battery pack is fed as operating power to an external load such as a portable radio transmitter.

Still another object of the present invention is to provide a portable signal light having coupled thereto a self-generator, which is operated by power generated in the self-generator and performs its function through a single color or multiple colors.

In order to achieve the above objects, according to one aspect of the present invention, there is provided a portable signal light comprising: a signal light section having a hollow signal light body to an inner surface of which a light emitting sheet is attached, a vertically positioned panel which is located inside the hollow signal light body, a plurality of LED elements which are fastened to the vertically positioned panel to be spaced apart one from another by a predetermined distance, and an illuminating lamp which is integrally secured to the hollow signal light body; and a self-generator for generating power to be fed as operating power to the LED elements of the signal light section, the illuminating lamp and an external load.

A generator body of the self-generator is integrally or detachably coupled to the hollow signal light body of the signal light section.

Preferably, the self-generator comprises an operating lever one end of which is pivotably coupled to the generator body and which has integrally formed therewith a transmitting lever for transmitting external force, a plurality of gears which are rotated in response to the external force transmitted by the medium of the transmitting lever, a generator module which is rotated by stepwise speed-varied rotation of the plurality of gears to generate power, a reverse rotation-preventing gear which has a reverse rotation-preventing structure for preventing reverse rotation force from being applied to the generator module while external force is removed from the operating lever, intermediate gears for transmitting to a shaft gear of the generator module rotation force received from the reverse rotation-preventing gear, a feeding port for externally feeding a voltage generated in the generator module, and a battery pack which is detachably assembled to the generator body to receive power through the feeding port and thereby be charged with the power.

A magnet member which has inclinedly magnetized N and S poles is installed on an inner wall surface of a rotor of the generator module, and a weight for increasing inertial rotation force is added to the rotor of the generator module.

According to another aspect of the present invention, there is provided a portable signal light comprising: a signal light section having a signal light body to an inner surface of which a light emitting sheet is attached, a vertically positioned panel which is located inside the signal light body, first and second columns of LED elements which are fastened to the vertically positioned panel to emit light of different colors from each other, and an illuminating lamp which is integrally secured to an outer surface of the signal light body; and a self-generator connected to the signal light body for generating power to be fed as operating power to the first and second columns of LED elements and the illuminating lamp.

Preferably, the first column of LED elements are a red color emitting type and the second column of LED elements are a green color emitting type; and a power switch is provided to the signal light body for selective driving of the first or second column of LED elements and driving of the illuminating lamp.

According to the present invention, the light emitting sheet has a green color.

Preferably, a generator body of the self-generator is integrally or detachably coupled to a lower end of the signal light body.

Advantageously, a battery pack which is charged with generated power and functions to externally feed charged power is detachably assembled to the generator body.

Further, a magnet member which has inclinedly magnetized N and S poles is installed on an inner wall surface of a rotor of a generator module.

A weight for increasing inertial rotation force is added to the rotor of the generator module.

### BRIEF DESCRIPTION OF THE DRAWINGS

The above objects, and other features and advantages of the present invention will become more apparent after a reading of the following detailed description when taken in conjunction with the drawings, in which:

FIG. 1 is a partially enlarged perspective view illustrating a construction of a portable signal light having a self-generator in accordance with a first embodiment of the present invention;

FIG. 2 is a perspective view independently illustrating an appearance of the self-generator of FIG. 1;

FIG. 3 is an exploded perspective view illustrating a detachable coupling structure between a battery pack and the self-generator shown in FIG. 2;

FIG. 4 is a side cross-sectional view illustrating an internal structure of the self generator shown in FIGS. 2 and 3;

FIG. 5 is a perspective view illustrating a reverse rotation-preventing structure of a reverse rotation-preventing gear shown in FIG. 4;

FIG. 6 is an electrical systematic view of the portable signal light having a self-generator according to the first embodiment of the present invention;

FIG. 7 is a perspective view illustrating a modification of the portable signal light having a self-generator according to the first embodiment of the present invention;

FIG. 8 is a perspective view illustrating a variation of the portable signal light having a self-generator shown in FIG. 7;

FIG. 9 is a partially enlarged perspective view illustrating a construction of a portable signal light having a self-generator in accordance with a second embodiment of the present invention;

FIG. 10 is a perspective view illustrating a modification of the portable signal light having a self-generator according to the second embodiment of the present invention;

FIG. 11 is a perspective view illustrating a variation of the portable signal light having a self-generator shown in FIG. 10; and

FIG. 12 is an electrical systematic view of the portable signal light having a self-generator according to the second embodiment of the present invention.

### BEST MODE FOR CARRYING OUT THE INVENTION

Reference will now be made in greater detail to a preferred embodiment of the invention, an example of which is illustrated in the accompanying drawings. Wherever, possible, the same reference numerals will be used throughout the drawings and the description to refer to the same or like parts.

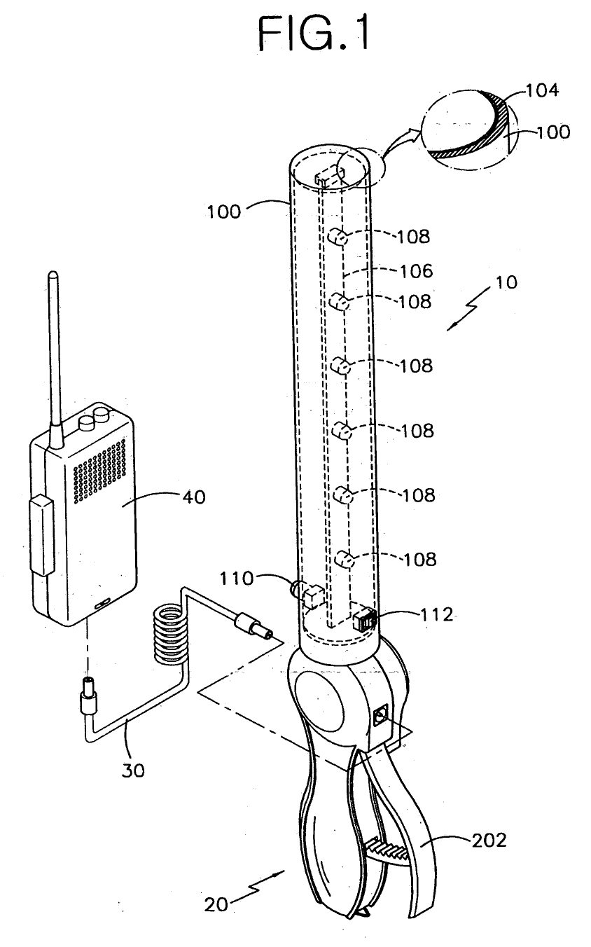

FIG. 1 is a partially enlarged perspective view illustrating a construction of a portable signal light having a self-generator in accordance with a first embodiment of the present invention.

In FIG. 1, the reference numeral 10 represents a signal light section which constitutes a portable signal light and is designed to have a structure for emitting light of a specific color. The reference numeral 20 represents a self-generator which is integrally coupled to the signal light section 10 to feed operating power to the signal light section 10 or an external load (for example, a portable radio transmitter).

In the signal light section 10, a light emitting sheet 104 for emitting light is attached to an inner wall surface of a signal light body 100 which has a cylindrical shape. A vertically positioned panel 106 is fixedly located inside the signal light body 100. A plurality of LED elements 108 each capable of emitting red light are fastened to the vertically positioned panel 106 in such a way as to be spaced apart one from another by a predetermined distance.

Also, a lamp 110 for illuminating a certain area is integrally secured to an outer surface of the signal light body 100 at a predetermined first position. A slide type power switch 112 which has a first contact for lighting the LED elements 108 and a second contact for lighting both of the LED elements 108 and the lamp 110 is provided on the outer surface of the signal light body 100 at a predetermined second position which is 180° separated from the first predetermined position.

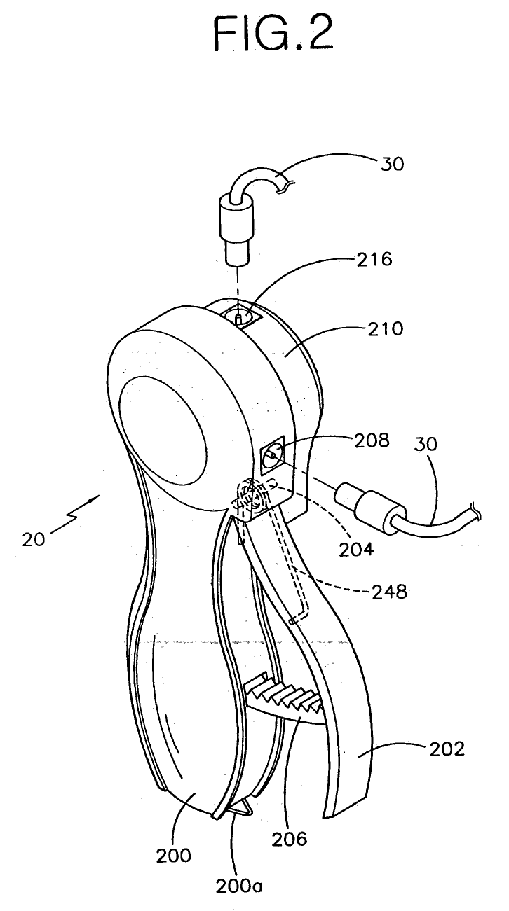

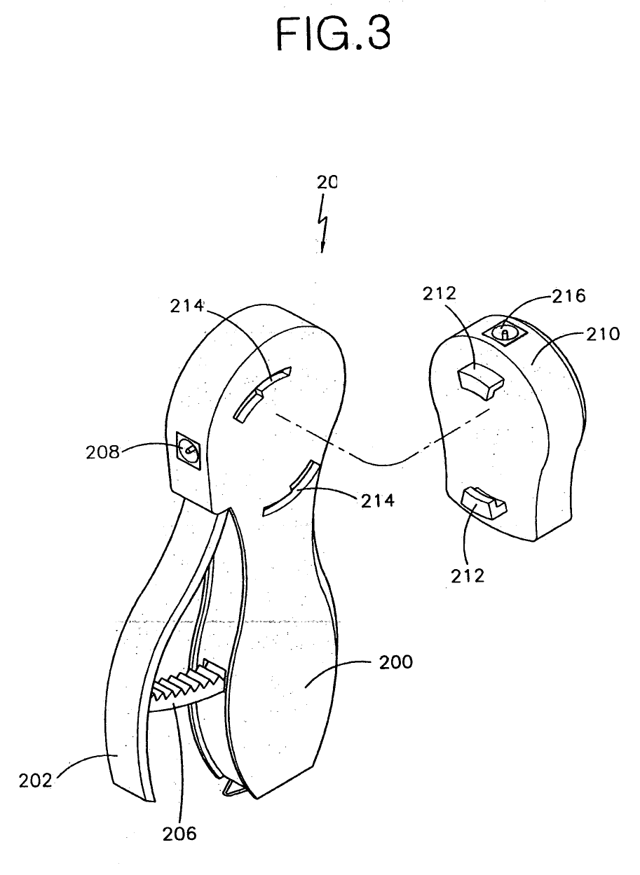

FIGS. 2 through 5 illustrate a self-generator which can be applied to the portable signal light of FIG. 1.

Referring to the drawings, the self-generator 20 has a generator body 200. An operating lever 202 for providing external force is pivotably coupled to a side surface of the generator body 200 by a pivot shaft 204. A transversely extending transmitting lever 206 for transmitting external force is integrally formed adjacent to a lower end of the operating lever 202. Gear teeth are formed on an upper surface of the transmitting lever 206.

Preferably, the above-described side surface of the generator body 200 is defined with a recess. Then, in a state wherein the operating lever 202 is received in the recess, by hooking a locking member 200a provided to a lower surface of the generator body 200 on the lower end of the operating lever 202, the operating lever 202 can be fixedly received in the recess.

A feeding port 208 for feeding generated power, as operating power, to an external load, for example, the portable radio transmitter 40 (see FIG. 1) or the LED elements 108 of the signal light section 10 by the medium of a power line 30 is formed on the side surface adjacent to an upper end of the generator body 200.

Further, a battery pack 210 which has a multitude of charging cells is detachably assembled to a rear surface of the generator body 200. A pair of engaging projections 212 are integrally formed on a front surface of the battery pack 210. Distal ends of the pair of engaging projections 212 are bent toward each other. A pair of circular arc-shaped engaging grooves 214 are defined on the rear surface of the generator body 200. By engaging the projections 212 into the grooves 214 and rotating the battery pack 210 in one direction, the battery pack 210 is stably assembled to the generator body 200. If the battery pack 210 is rotated in the other direction, as the engaging projections 212 are disengaged from the engaging grooves 214, the battery pack 210 can be disassembled from the generator body 200.

A power port 216 for receiving power from the feeding port 208 via the power line 30 to be charged with the power and for feeding charged power to the portable radio transmitter 40 serving as the external load is formed on an upper end surface of the battery pack 210.

Inside the generator body 200, there is provided a first rotation gear 220 which is rotatably supported by a first rotation shaft 220a. The first rotation gear 220 is meshed with the gear teeth which are formed on the upper surface of the transmitting lever 206. A first interlocked gear 222 is integrally provided to the first rotation gear 220. The first interlocked gear 222 is coupled to the first rotation shaft 220a concentrically with the first rotation shaft 220. A first intermediate gear 224 which is rotatably supported by a second rotation shaft 224a is meshed with the first interlocked gear 222. A second interlocked gear 226 is integrally provided to the first intermediate gear 224 in a concentrical relationship with the second rotation shaft 224a.

A second intermediate gear 228 which is coupled to a third rotation shaft 228a is meshed with the second interlocked gear 226. A reverse rotation-preventing gear 230 is coupled to the third rotation shaft 228a in a concentrical relationship with the second intermediate gear 228. The reverse rotation-preventing gear 230 has a reverse rotation-preventing structure which prevents reverse rotation force from being transmitted downstream when viewed in a force transmitting direction.

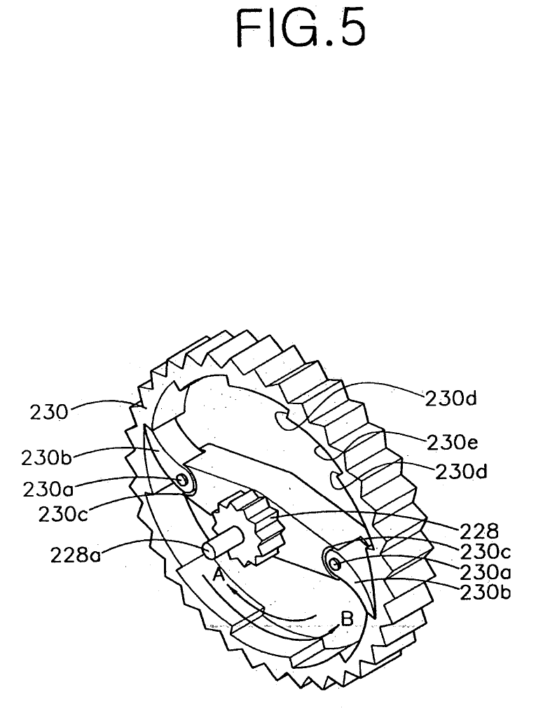

In the reverse rotation-preventing structure as shown in FIG. 5, the second intermediate gear 228 which is meshed with the second interlocked gear 226 and rotatably supported by the third rotation shaft 228a, is provided at a side of the reverse rotation-preventing gear 230. The second intermediate gear 228 has an elongate portion. The elongate portion is integrally formed on a surface of the second intermediate gear 228 which surface faces the reverse rotation-preventing gear 230. A pair of pawl pieces 230b are pivotably connected to both ends, respectively, of the elongate portion of the second intermediate gear 228, by a pair of pivot, pins 230a. The pawl pieces 230b are respectively prevented from being reversely rotated by a pair of stopper projections 230c which are formed at both ends of the elongate portion of the second intermediate gear 228, whereby rotation force of the second intermediate gear 228 is transmitted to the reverse rotation-preventing gear 230 only in a forward direction (shown by an arrow A in FIG. 5).

Moreover, ratchet teeth 230d are formed on a circumferential inner surface of the reverse rotation preventing gear 230 which is defined with a depression, in a manner such that they are spaced apart one from another by a predetermined angle. When the pair of pawl pieces 230b are respectively engaged with the ratchet teeth 230d, the rotation force of the second intermediate gear 228 is transmitted to the reverse rotation-preventing gear 230 to be integrally rotated with each other. A sliding guide surface 230e is formed between two adjoining ratchet teeth 230d. The pawl piece 230b can freely slide on the sliding guide surface 230e.

Consequently, by the reverse rotation-preventing structure, as external force is exerted to the operating lever 202, if the second interlocked gear 226 is rotated, the second intermediate gear 228 which is meshed with the second interlocked gear 226 is also rotated in the direction shown by the arrow A in FIG. 5. If the second intermediate gear 228 is rotated in the direction shown by the arrow A, the pair of pawl pieces 230b which are pivotably connected to both ends of the elongate portion of the second intermediate gear 228 are respectively engaged with the ratchet teeth 230d which are formed on the circumferential inner surface of the reverse-rotation preventing gear 230. By this, as the rotation force of the second intermediate gear 228 is transmitted to the reverse rotation-preventing gear 230, the reverse rotation-preventing gear 230 is also rotated in the same direction (that is, the direction shown by the arrow A in FIG. 5) as the second intermediate gear 228.

On the contrary, if the external force which is exerted to the operating lever 202 is removed, as the transmitting lever 206 which is integrally formed with the operating lever 202 is pulled outward by the presence of an elastic member 248 (see FIG. 1), the second intermediate gear 228 is reversely rotated. However, the pair of pawl pieces 230b which are respectively provided to both ends of the elongate portion of the second intermediate gear 228 are reversely rotated (in a direction shown by an arrow B in FIG. 5) while sliding on the sliding guide surfaces 230e each of which is formed between two adjoining ratchet teeth 230d. Hence, the second intermediate gear 228 is rotated independently of the reverse rotation-preventing gear 230, and the reverse rotation-preventing gear 230 is continuously and inertially rotated in the current rotating direction.

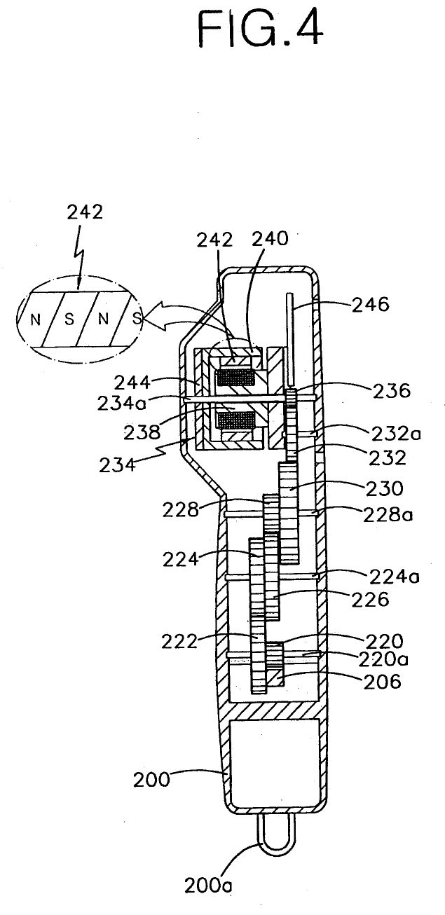

Referring to FIG. 4, a third intermediate gear 232 which is rotatably coupled to a fourth rotation shaft 232a is meshed with the reverse rotation-preventing gear 230. A shaft gear 236 which is integrally coupled to a motor rotation shaft 234a of a generator module 234 is meshed with the third intermediate gear 232.

Preferably, according to the present invention, by properly determining gear ratios among the gears 220, 222, 224, 226, 228, 230 and 232, the shaft gear 236 of the generator module 234 can be rotated at a high RPM.

The generator module 234 has a stator 238 and a rotor 240. The stator 238 is fixedly positioned around the shaft gear 236 and has a core around which a coil is wound by a predetermined turns. The rotor 240 is arranged radially outward of the stator 238 and integrally coupled to the motor rotation shaft 234a. An annular magnet member 242 which has alternately located N and S poles is installed on an inner wall surface of the rotor 240 of the generator module 234. The N and S poles of the magnet member 242 are inclinedly magnetized to improve a rotation torque of the rotor 240.

In order to increase inertial rotation force of the rotor 240, a weight 244 which is integrally coupled to the motor rotation shaft 234a is added to the rotor 240. Additionally, a PCB 246 is provided to the generator module 234. The PCB 246 has circuits for smoothing generated power outputted from the stator 238 and for converting smoothed power into a DC level. The feeding port 208 is electrically connected to an output terminal of the PCB 246.

In order to return the operating lever 202 to its initial standby position when external force exerted to the operating lever 202 is removed, one end of the elastic member 248 which is fitted around the pivot shaft 204 is fastened to the generator body 200, and the other end of the elastic member 248 is brought into contact with a lower surface of the operating lever 202.

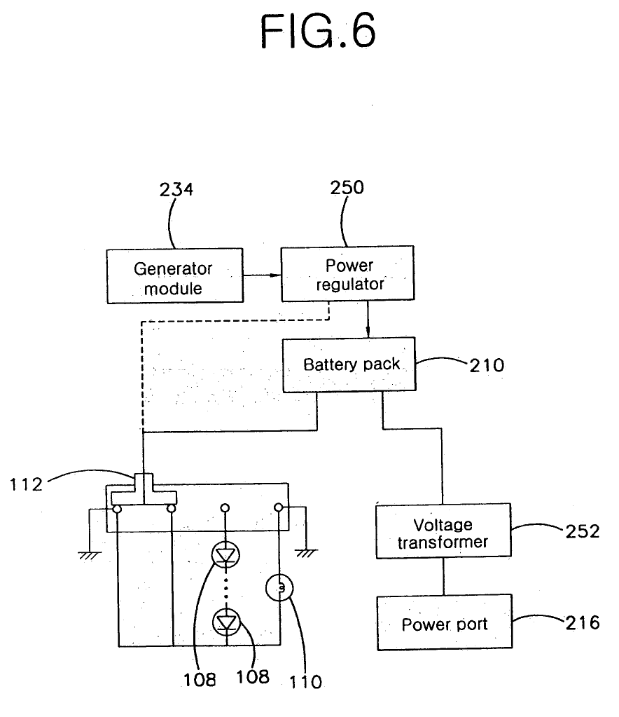

FIG. 6 is an electrical systematic view of the portable signal light having a self-generator according to the first embodiment of the present invention.

Power which is generated in the generator module 234 by repetitive operation of the operating lever 202 is smoothed by a power regulator 250 which is designed to be located on the PCB 246, converted into a DC level, applied from the feeding port 208 through the power line 30 to the power port 216, and charged into the charging cells of the battery pack 210.

Power which is charged into the battery pack 210 is decreased or boosted in its voltage level by a voltage transformer 252 and then fed, as operating power, through the power port 216 to the portable radio transmitter 40 serving as the external load.

Power which is smoothed and converted into a DC level by the power regulator 250 is fed so that only the LED elements 108 are lighted (or flickered) or both of the LED elements 108 and the lamp 110 are simultaneously lighted depending upon a position of the power switch 112.

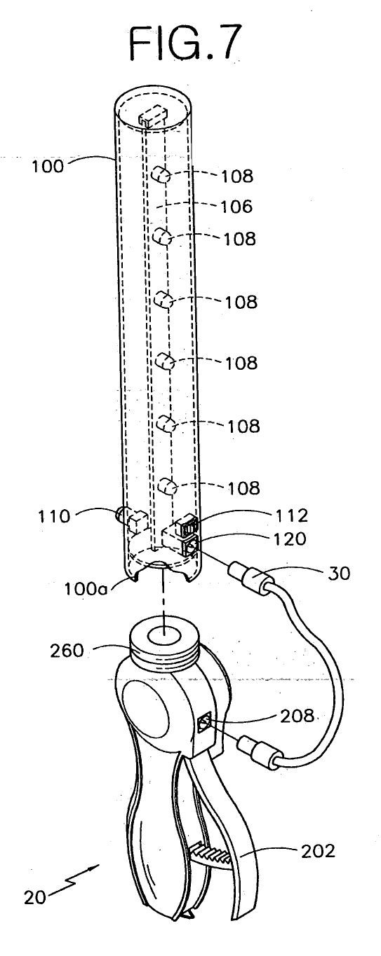

Here, according to the present invention, if the signal light body 100 of the signal light section 10 and the generator body 200 of the self-generator 20 are integrally coupled with each other, even though power of a DC level which is fed from the power regulator 250 can be applied through the power switch 112 to the LED elements 108 or both of the LED elements 108 and the lamp 110, it can also be envisaged that a receiving port corresponding to the feeding port 108 is formed at a predetermined location on the signal light body 100 (as will be described later with reference to FIG. 7), and power charged into the battery pack 210 is fed from the power port 216 through the power line 30 to the receiving port, whereby the LED elements 108 or both of the LED elements 108 and the lamp 110 are operated by power received by the receiving port.

In the portable signal light having coupled thereto a self-generator in accordance with the first preferred embodiment of the present invention, if the operating lever 202 is unlocked from the locking member 200a provided to the lower surface of the generator body 200, the operating lever 202 is released from the recess defined on the side surface of the generator body 200 and moved to the initial standby position by elastic force of the elastic member 248. In this state, if the operating lever 202 is pressed, the transmitting lever 206 which is integrally connected to the operating lever 202 rotates the first rotation gear 220. Rotation of the first rotation gear 220 is transmitted through the first interlocked gear 222 to the first intermediate gear 224, and thereby the first intermediate gear 224 and the second interlocked gear 226 are rotated.

By rotation of the second interlocked gear 226, the second intermediate gear 228 is rotated. Upon rotation of the second intermediate gear 228, as the pair of pawl pieces 230b are engaged with the ratchet teeth 230d which are formed on the circumferential inner surface of the reverse rotation-preventing gear 230, the rotation of the second intermediate gear 228 is transmitted to the reverse rotation-preventing gear 230, and thereby, the reverse rotation-preventing gear 230 is also rotated.

By the rotation of the reverse rotation-preventing gear 230, the shaft gear 236 is rotated at a predetermined RPM by the medium of the third intermediate gear 232. Also, by rotation of the shaft gear 236, the rotor 240 which has installed on the inner wall surface thereof the magnet member 242 is rotated about the stator 238. The rotation of the rotor 240 is executed while a torque is sufficiently secured by inclined arrangement of the N and S poles. By the presence of the weight 244, inertial rotation force of the rotor 240 can be secured in a sufficient manner.

On the other hand, if external force exerted to the operating lever 202 is removed, the operating lever 202 is returned to its initial standby position by the elastic member 248. If the operating lever 202 is returned to the initial standby position, as the transmitting lever 206 is pulled outward, although the gears 220, 222, 224, 226 and 228 are reversely rotated, the pair of pawl pieces 230b which are provided to both ends of the elongate portion of the second intermediate gear 228 slide on the sliding guide surfaces 230e each of which is formed between two adjoining ratchet teeth 230d while being rotated in the reverse direction (shown by the arrow B in FIG. 5). Thus, the reverse rotation-preventing gear 230 is prevented from being reversely rotated and continues to execute inertial rotation in the current rotating direction, whereby inertial rotation of the third intermediate gear 232 and the shaft gear 236 is also maintained.

Accordingly, by repetitive operation of the operating lever 202, a preset voltage level is created in the generator module 234. This voltage is smoothed and converted into a DC level by the voltage regulator 250 which is located on the PCB 246, and then, fed from the feeding port 208 through the power line 30 to the power port 216 of the battery pack 210 to charge the battery pack 210.

Power which is charged into the battery pack 210 can be fed from the power port 216 through the power line 30 in a manner such that the LED elements 108 are emitted or both of the LED elements 108 and the lamp 110 are emitted and lighted depending upon a position of the power switch 112.

Here, it can be contemplated that power for driving the LED elements 108 and the lamp 110 is directly applied thereto from the power regulator 250.

Further, power which is charged into the battery pack 210 is also fed, as operating power, from the power port 216 through the power line 30 to the portable radio transmitter 40 serving as the external load.

FIG. 7 is a perspective view illustrating a modification of the portable signal light having a self-generator according to the first embodiment of the present invention.

In its entirety the portable signal light as shown in FIG. 7 is similarly constructed to that according to the above-described first embodiment, except that the signal light body 100 of the signal light section 10 and the generator body 200 of the self-generator 20 are designed to render a detachable structure.

That is to say, an internally threaded portion 100a is formed on the inner wall surface of the signal light body 100 of the signal light section 10, and corresponding to this, an externally threaded portion is formed on a circumferential outer surface of an upward extending portion 260 which is formed on an upper end of the generator body 200 of the self-generator 20.

As a consequence, owing to the presence of the internally threaded portion 100a and the externally threaded portion, the signal light body 100 and the generator body 200 can be detachably coupled to each other.

Here, in order to feed operating power to the LED elements 108 and the lamp 110 which constitute the signal light body 100, a receiving port 120 is formed at a predetermined position on the signal light body 100. By this, the charged power is fed from the power port 216 of the battery pack 210 (or from the feeding port 208) through the power line 30 to the receiving port 120.

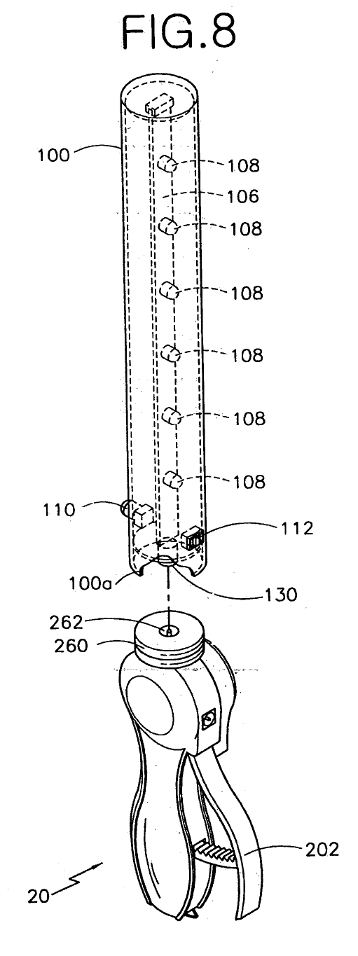

FIG. 8 is a perspective view illustrating a variation of the portable signal light having a self-generator shown in FIG. 7.

In the construction shown in FIG. 8, a power receiving jack 130 is formed at a center portion of a lower end of the signal light body 100, and a power feeding jack 262 which corresponds to the power receiving jack 130 is formed at a center portion of the upward extending portion 260 of the generator body 200 of the self-generator 20, whereby power can be directly applied from the power regulator 250 to the LED elements 108 and the lamp 110 via the power feeding jack 262 and the power receiving jack 130.

That is to say, if the internally threaded portion 100a which is formed on the inner wall surface of the signal light body 100 and the externally threaded portion which is formed on the circumferential outer surface of an upward extending portion 260 of the generator body 200 of the self-generator 20 are threadedly coupled with each other, power of the power regulator 250 is directly applied from the power feeding jack 262 of the upward extending portion 260 of the generator body 200 of the self-generator 20 to the power receiving jack 130 which is formed at the center portion of the lower end of the signal light body 100, to drive the LED elements 108 and the lamp 110.

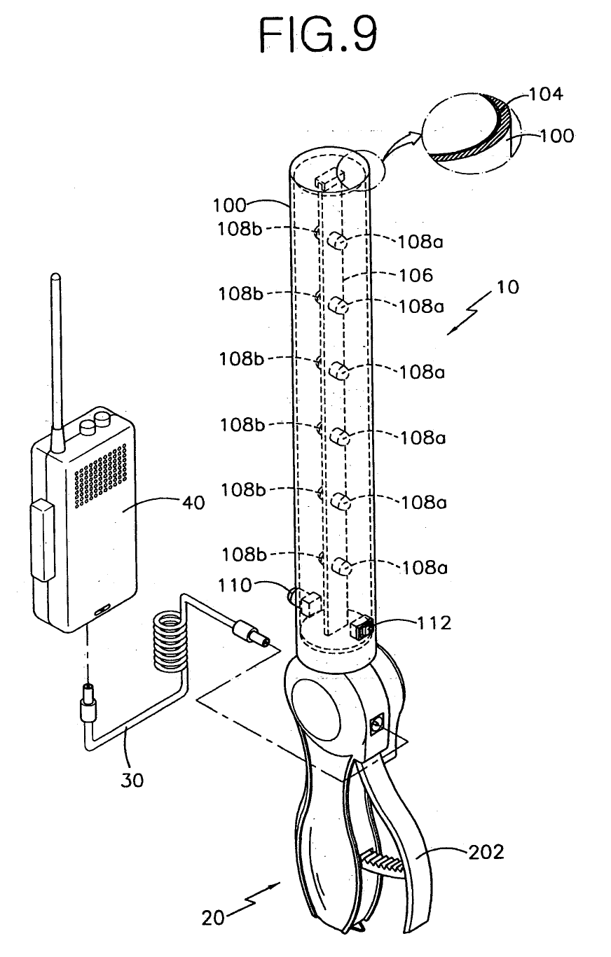

FIG. 9 is a partially enlarged perspective view illustrating a construction of a portable signal light having a self-generator in accordance with a second embodiment of the present invention.

In this second embodiment of the present invention, a plurality of first LED elements 108a for emitting light of a first color (for example, a red color) and a plurality of second LED elements 108b for emitting a second color (for example, a green color) are fastened to both surfaces, respectively, of the vertically positioned panel 106 which is located inside the signal light body 100 of the signal light section 10, in a manner such that selective light emitting for the red and green colors can be effected. The LED elements 108a and 108b are spaced apart one from another by a predetermined distance.

The light emitting sheet 104 which is attached to the inner wall surface of the signal light body 100 has a green color so that it transmits the red-colored light emitted from the first LED elements 108a and is not influenced at all by the green-colored light emitted from the second LED elements 108b.

In this construction, power generated by the self-generator 20 as described in the first embodiment of the present invention selectively allow the first column of LED elements 108a to emit red light, the second column of LED elements 108b to emit green light, and/or the lamp 110 to be lighted, depending upon a position of the power switch 112.

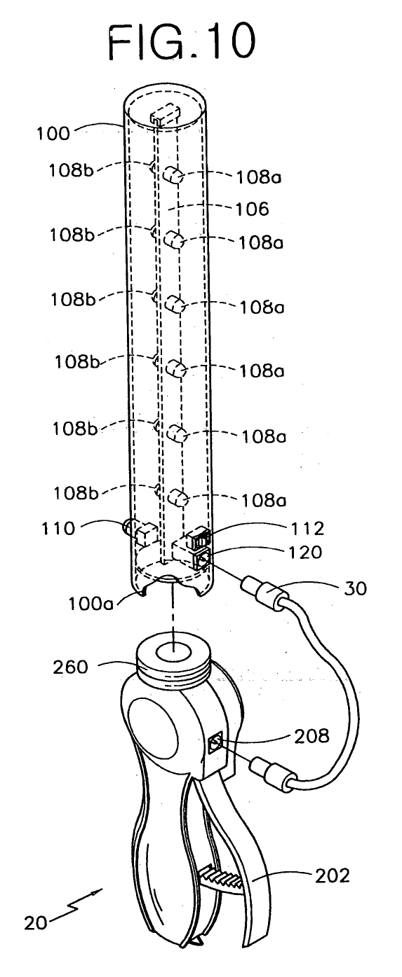

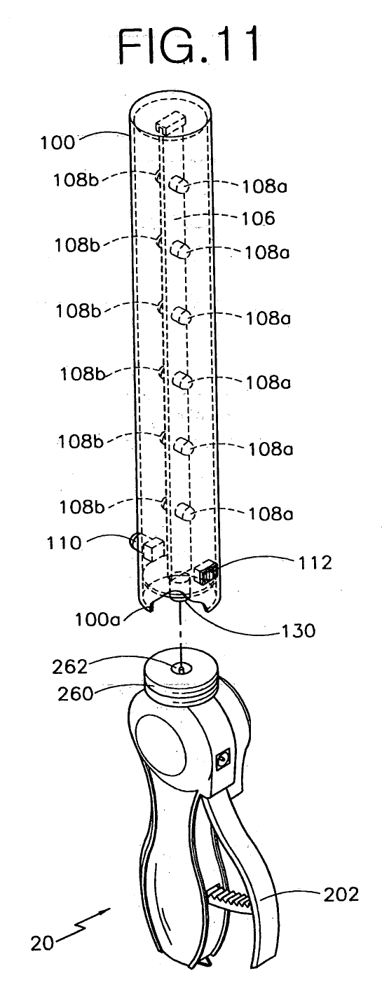

FIG. 10 is a perspective view illustrating a modification of the portable signal light having a self-generator according to the second embodiment of the present invention; and FIG. 11 is a perspective view illustrating a variation of the portable signal light having a self-generator shown in FIG. 10.

Referring to FIG. 10, by the construction shown in FIG. 7 of the first embodiment which uses a first column of LED elements 108a for emitting a first color and a second column of LED elements 108b for emitting a second color, selective lighting of the first or second color is made possible.

Referring to FIG. 11, by the construction shown in FIG. 8 of the first embodiment which uses a first column of LED elements 108a for emitting a first color and a second column of LED elements 108b for emitting a second color, selective lighting of the first or second color is made possible.

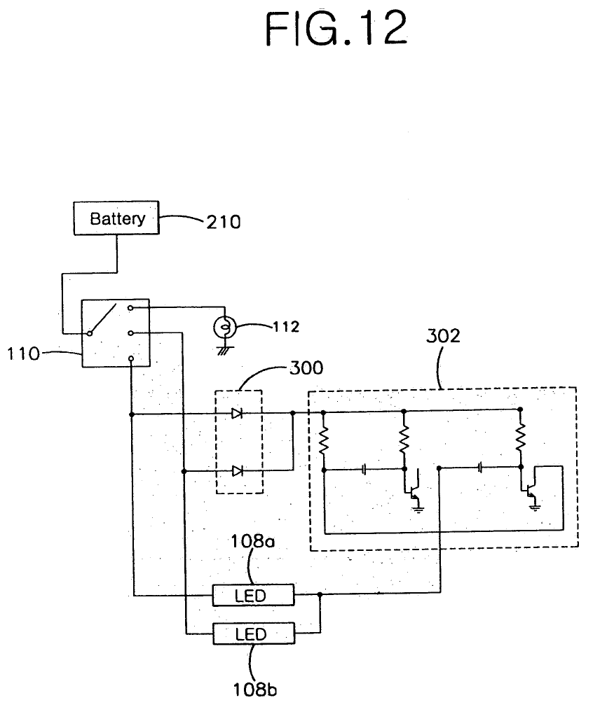

FIG. 12 is an electrical systematic view of the portable signal light having a self-generator according to the second embodiment of the present invention.

Referring to FIG. 12, power generated by the self-generator 12 is applied from the power regulator located on the PCB 246 to the power switch 112 or from the battery pack 210 through the power line 30 to the power switch 112, in a manner such that, depending upon a position of the power switch 112, the power is applied to drive the lamp 110 or to one ends of the first and second columns of LED elements 108a and 108b. The other ends of the first and second columns of LED elements 108a and 108b are commonly connected to an output terminal of a multi-vibrator 302 which performs a vibrating function by power rectified in a rectifier 300.

Therefore, in this second embodiment of the present invention, by repetitive operation of the operating lever 202 of the self-generator 20, power generated by the generator module 234 can be applied directly from the power regulator 250, or from the feeding port 208 or the battery pack 210 through the power line 30.

In this state, by establishing the power switch 112 to a lamp lighting position, the lamp 110 is lighted. If the switch 112 is slid toward for example a second contact, red-colored light is emitted from the first column of the LED elements 108a.

Namely, power which flows through the power switch 112 is rectified in the rectifier 300 and then applied to the multi-vibrator 302. By this, the multi-vibrator 302 is vibrated through charging and discharging of a capacitor. A vibration output of the multi-vibrator 302 is applied to the first column of LED elements 108a, and thereby, red-colored light is flickered from the first column of LED elements 108a. Here, light signal of the red color which is vibrated in the first column of LED elements 108a is not influenced by the light emitting sheet 104 of the green color and emitted as it is.

If the power switch 112 is slid toward a third contact, the red-colored light is emitted from the first column of LED elements 108a and at the same time the green-colored light is emitted from the second column of LED elements 108b. At this time, as the green-colored light emitted from the second column of LED elements 108b passes through the light emitting sheet 104 of the green color, normal green-colored light is emitted.

If the external load such as the portable radio transmitter is connected to the power port 216 of the battery pack 210 through the power, line 30, feeding of charged power (or operating power) to the external load is enabled.

### Industrial Application

As described above, the portable signal light having coupled thereto the self-generator according to the present invention provides advantages in that, since power generated in the self-generator is employed to drive LED elements, a battery replacing necessity is eliminated and efficiency is accomplished in terms of economy.

Further, by the fact that power charged into a battery pack which is detachably assembled to the self-generator can be applied, as operating power, to an external load such as a portable radio transmitter, an abnormal operating status or an operation disabled status of the portable signal light or the external load which is otherwise caused due to power depletion of a battery can be avoided.

Moreover, because the portable signal light having coupled thereto the self-generator can selectively emit light of a single color (a red color) or multiple colors (red and green colors) using self-generated power, color identifiability is improved. Furthermore, due to the fact that a lamp for illuminating purpose is integrally provided to the portable signal light, it is possible to illuminate a certain area without using a separate illuminating implement.

In the drawings and specification, there have been disclosed typical preferred embodiments of the invention and, although specific terms are employed, they are used in a generic and descriptive sense only and not for purposes of limitation, the scope of the invention being set forth in the following claims.

1. A portable signal light comprising:
a signal light section having a hollow signal light body to an inner surface of which a light emitting sheet is attached, a vertically positioned panel which is located inside the hollow signal light body, a plurality of LED elements which are fastened to the vertically positioned panel to be spaced apart one from another by a predetermined distance, and an illuminating lamp which is integrally secured to the hollow signal light body; and
a self-generator for generating power to be fed as operating power to the LED elements of the signal light section, the illuminating lamp and an external load.

2. The portable signal light as claimed in claim 1, wherein a generator body of the self-generator is integrally coupled to the hollow signal light body of the signal light section.

3. The portable signal light as claimed in claim 1, wherein a generator body of the self-generator is detachably coupled to the hollow signal light body of the signal light section.

4. The portable signal light as claimed claim 1, wherein the self-generator comprises an operating lever one end of which is pivotably coupled to the generator body and which has integrally formed therewith a transmitting lever for transmitting external force, a plurality of gears which are rotated in response to the external force transmitted by the medium of the transmitting lever, a generator module which is rotated by stepwise speed-varied rotation of the plurality of gears to generate power, a reverse rotation-preventing gear which has a reverse rotation-preventing structure for preventing reverse rotation force from being applied to the generator module while external force is removed from the operating lever, intermediate gears for transmitting to a shaft gear of the generator module rotation force received from the reverse rotation-preventing gear, a feeding port for externally feeding a voltage generated in the generator module, and a battery pack which is detachably assembled to the generator body to receive power through the feeding port and thereby be charged with the power.

5. The portable signal light as claimed in claim 4, wherein a magnet member which has inclinedly magnetized N and S poles is installed on an inner wall surface of a rotor of the generator module.

6. The portable signal light as claimed in claims 4 or 5, wherein a weight for increasing inertial rotation force is added to the rotor of the generator module.

7. A portable signal light comprising:
a signal light section having a signal light body to an inner surface of which a light emitting sheet is attached, a vertically positioned panel which is located inside the signal light body, first and second columns of LED elements which are fastened to the vertically positioned panel to emit light of different colors from each other, and an illuminating lamp which is integrally secured to an outer surface of the signal light body; and
a self-generator connected to the signal light body for generating power to be fed as operating power to the first and second columns of LED elements and the illuminating lamp.

8. The portable signal light as claimed in claim 7, wherein the first column of LED elements are a red color emitting type and the second column of LED elements are a green color emitting type; and a power switch is provided to the signal light body for selective driving of the first or second column of LED elements and driving of the illuminating lamp.

9. The portable signal light as claimed in claims 7 or 8, wherein the light emitting sheet has a green color.

10. The portable signal light as claimed in claim 7, wherein a generator body of the self-generator is integrally coupled to a lower end of the signal light body.

11. The portable signal light as claimed in claim 7, wherein a generator body of the self-generator is detachably coupled to a lower end of the signal light body.

12. The portable signal light as claimed in claim 7, wherein the self-generator comprises an operating lever one end of which is pivotably coupled to the generator body and which has integrally formed therewith a transmitting lever for transmitting external force, a plurality of gears which are rotated in response to the external force transmitted by the medium of the transmitting lever, a generator module which is rotated by stepwise speed-varied rotation of the plurality of gears to generate power, a reverse rotation-preventing gear which has a reverse rotation-preventing structure for preventing reverse rotation force from being applied to the generator module while external force is removed from the operating lever, intermediate gears for transmitting to a shaft gear of the generator module rotation force received from the reverse rotation-preventing gear, a feeding port for externally feeding a voltage generated in the generator module, and a battery pack which is detachably assembled to the generator body to receive power through the feeding port and thereby be charged with the power.

13. The portable signal light as claimed in claim 12, wherein a magnet member which has inclinedly magnetized N and S poles is installed on an inner wall surface of a rotor of the generator module.

14. The portable signal light as claimed in claims 12 or 13, wherein a weight for increasing inertial rotation force is added to the rotor of the generator module.
